(19) United States
(12) Patent Application Publication
(10) Pub. No.: US 2011/0183048 A1
(43) Pub. Date: Jul. 28, 2011

(54) Soluble Coffee Product

(76) Inventors: Ken Noble, Waupaca, WI (US); Samantha Peski, Fremont, WI (US)

(21) Appl. No.: 12/692,314

(22) Filed: Jan. 22, 2010

(51) Int. Cl. A23F 5/00; B65D 85/804

(52) U.S. Cl. 426/122; 426/595; 426/106

(57) ABSTRACT

Soluble coffee products include compressed coffee particles that can be blended with powdered or ground roast coffee products, oils and flavorings to produce dissolvable coffee beverages in a variety of flavors.

### SUMMARY

The present disclosure describes soluble coffee products that include compressed coffee particles. The coffee products can be dissolved in hot water in seconds to produce a tasty coffee beverage. In certain embodiments the coffee product is contained in a stick pack, which is a film, foil or film/foil-laminated stick pack containing enough soluble coffee to make a single serving. In certain embodiments the soluble coffee is contained in a tub or cartridge for use in a single serving coffee brewing machine. It is an aspect of the disclosure that in all embodiments of sealed packaging, the headspace within the package can be ambient or flushed with nitrogen gas. The soluble coffee product provides certain advantages in that no filter is required during brewing, allowing for a simpler and more cost effective product. The dry compressed soluble product becomes adherent when wetted and does not escape through the bottom of the tub during use. In addition, the disclosed formulas are dissolved throughout the “brew” cycle of a single serving coffee maker and thus provide dark liquid coffee into a cup or container during the entire brew cycle. Further advantages will be obvious to those of skill in the art.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is a side view of a soluble coffee product tub suitable for use in a single serving coffee brewer.

FIG. 1B is a perspective drawing of a soluble coffee product tub suitable for use in a single serving coffee brewer.

### DETAILED DESCRIPTION

The present disclosure can be described in certain embodiments as compressed coffee particle compositions. The compressed coffee product is composed of particles hardened by processes that can include the step of milling all dry particles of roasted coffee to a size that passes through a fine mesh sieve (10 to 30 mesh). Milling can be accomplished with various processes including, but not limited to use of a co-mill or rotary milled affixed with a fine mesh screen inserted. The micro-milled coffee is preblended in a high intensity blender with coffee oil and silicon food grade lubricant until uniform. The preblended materials are then blended with freeze dried and/or spray dried coffee extracts, plus any coffee caffeine and/or any other natural active coffee components, in a ribbon and/or plow configuration blender until uniform. The final blended material is fed into a roller compactor such as those marketed by Vector Corp or Fitzpatrick Co., or other similar make, affixed with flat, serrated, pocketed, or other shaped set of compression rolls. Pressure is applied (100-3000 psi) to compress the material into a ribbon type or elongated chunked material. This material is then cut down to the desired size using a co-mill or mild action device to the desired shape and particle size. The undesirable particle sizes are rerouted back into the feed and reprocessed. The desired particles (between 4 mesh and 25 mesh) are gathered into suitable containers, sealed and stored for packaging at a later date.

The present disclosure can be described in certain embodiments as a soluble coffee product that dissolves in hot water to produce a coffee beverage and is suitable for use in single serve coffee brewing machines. The soluble product is composed of freeze dried coffee, micro-milled coffee, coffee oil and optionally spray dried coffee extracts and/or caffeine powder isolated from, or derived from coffee. The soluble coffee product can be packaged in a tub or cartridge dimensioned to be held in a brewing chamber of a coffee machine that is designed to brew a single serving of coffee.

The coffee product can be produced from any type of coffee bean based on taste or cost, for example and in certain embodiments is produced from Arabica beans, Robusta beans or a combination of the two types of beans. It is further understood that the taste of the coffee beverage produced by the soluble coffee product will vary according to the level of roasting of the beans such as light, medium, dark, bold or espresso. Coffee beans can be roasted to any level known in the art by various names, including but not limited to light roasts such as cinnamon roast, half city, or New England, medium roasts such as full city, American, regular, breakfast or brown, full roasts such as high, Viennese, Italian, espresso or continental, or double roasted as in French roast. The roasted beans can then be blended as desired to produce a selected flavor, at least a portion of which is obtained from the soluble coffee product.

A soluble coffee product of the present disclosure can include from about 50% to about 99% freeze dried coffee, from 0 to about 50% spray dried coffee, from 0 to about 25% micro-milled coffee, from 0 to about 5% coffee oil, and from 0 to about 5% caffeine powder from coffee. Alternatively the coffee product can include 91 to 92% medium roast freeze dried coffee, 2 to 3% spray dried espresso roast coffee, 5 to 6% micro-milled medium roast coffee, 0.01 to 0.1% coffee oil and 0.05 to 0.2% caffeine powder from coffee, or 91 to 92% freeze dried medium roast coffee, 4 to 5% spray dried medium roast coffee, 4 to 5% micro-milled medium roast coffee, 0.01 to 0.1% coffee oil and 0.05 to 0.2% caffeine powder from coffee, or even 89 to 90% freeze dried medium roast coffee, 5 to 6% spray dried dark roast coffee, 5 to 6% micro-milled medium roast coffee, and 0.01 to 0.1% coffee oil, for example.

It is further contemplated that flavoring powders or oil can be used to produce a flavored soluble coffee product. Any suitable flavoring agent known in the art including but not limited to vanilla, peppermint, Irish crème, caramel, cinnamon, almond, hazelnut, toffee, buttered rum, orange or raspberry can be provided. Other agents such as soluble sweeteners, cream or artificial dairy product flavorings can also be added.

In certain embodiments, the soluble coffee product is contained in a sealed container, which can be sealed to isolate the contents from intrusion of water, light or air. The disclosure can in certain embodiments be described as soluble coffee product contained in a water, light, and air tight container, in an amount of the coffee product to produce a single serving of coffee upon addition of hot water. The headspace inside the package can be flushed with either ambient air or with nitrogen gas. A single serving container can contain from 1.0 gram to 10.0 grams of soluble coffee product, for example, and can produce a 6 oz or a 12 oz serving of coffee, for example. As in known in the art, single serving brewers can typically include piercing mechanisms that pierce both the top and bottom of cartridges held in the brewing chamber so that hot water enters the cartridge from the top and the finished beverage is released through the bottom and into a cup or other container.

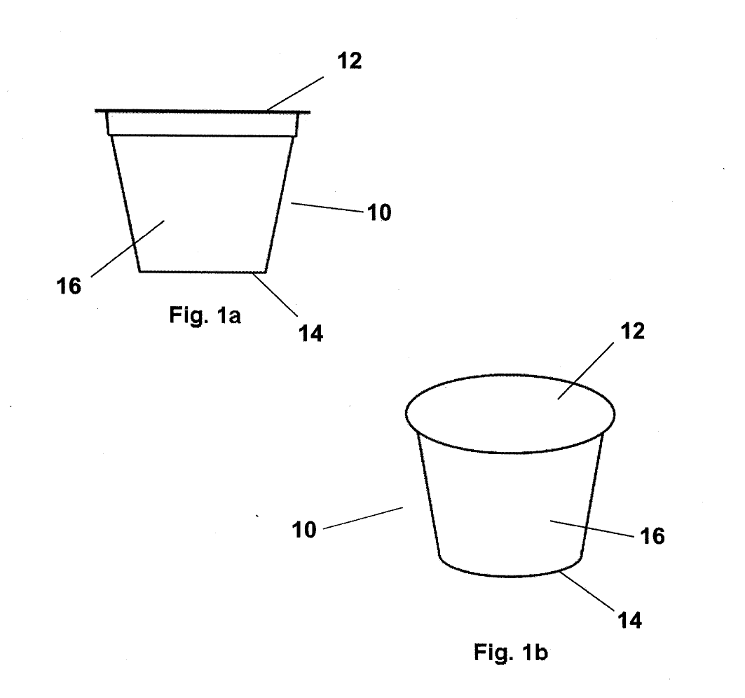

An exemplary container or tub 10 is shown in FIGS. 1A and 1B in which the top surface 12 and bottom surface 14 are circular in shape. The side wall 16 connects the top and bottom surfaces. The top surface 12 is typically a polymer foil that provides a readily piercable medium for a piercing mechanism. It is understood that the shape of the container is designed to conform to a particular coffee brewing device and that other shapes such as cones, or non-cylindrical shapes that conform to any geometrical shape such as squares, rectangles, triangles, pentagons, hexagons, etc, are also contemplated.

The disclosure can be described, then, in certain embodiments as a tub, wherein the tub comprises a substantially planar bottom surface, a substantially planar top surface and one or more side walls that connect the bottom surface to the top surface, and wherein the bottom surface, the top surface and the one or more side walls enclose the interior volume of the tub in an air and water tight seal, and further wherein the interior of the tub contains a soluble coffee product comprising freeze dried roasted coffee, micro-milled roasted coffee, natural coffee extract additives and coffee oil in an amount to produce a single serving of coffee beverage when mixed a predetermined amount of water.

In certain embodiments the tub includes circular top and bottom surfaces in which the top surface has a larger circumference than that of the bottom surface sized to fit into the brewing chamber of a single serving coffee brewer. The tub can be composed of a resilient plastic material and the top surface can be made of foil. In the disclosed tubs, the top and bottom surfaces are each piercable, or include a piercable region.

Various components can be blended into the soluble coffee product including but not limited to freeze dried coffee, spray dried coffee extract, micro-milled roasted coffee, coffee oil and caffeine powder from coffee, wherein the components can be produced from either Arabica or Robusta coffee beans roasted to a light, medium, dark or espresso flavor in any combination.

The soluble coffee product can contain from about 50 to about 99% freeze dried coffee, from 0 to about 50% spray dried coffee, from 0 to about 25% micro-milled coffee, from 0 to about 5% coffee oil, and from 0 to about 5% caffeine powder from coffee. It is understood that the composition of the products are chosen for a variety of tastes and strengths and thus the exact percentages of the ingredients can vary.

The term, about, is used to indicate that in certain embodiments, the percentage of a particular ingredient can be near but outside the limit of the described range. Such variance is contemplated to include values of ±10% of the range limits. The term “substantially” as applied to a shape such as a substantially planar surface indicates that the surface is largely, but not necessarily completely planar. The term indicates that minor areas of non-planarity can exist in a substantially planar surface that can be due to manufacturing or material imperfections or defects, or through post-manufacturing conditions.

Table 1 contains exemplary formulas of three soluble coffee products of the present disclosure including a light roast, a medium roast, and a dark roast product.

TABLE 1

| | Light Roast | Medium Roast | Dark Roast |
|---|---|---|---|
| Freeze Dried Columbian | 91.95% | 91.645% | 89.69% |
| Medium Roast Coffee | | | |
| Spray Dried Espresso | 2.6% | 4.17% | 5.13% |
| Roast Coffee | | | |
| Spray Dried Brazilian | 0 | 0 | 0 |
| Medium Roast Coffee | | | |
| Spray Dried Dark | 0 | 0 | 0 |
| Roast Coffee | | | |
| Micro-Milled Medium | 5.3% | 4.17% | 5.13% |
| Roast Coffee | | | |
| Coffee Oil, Brazilian | 0.05% | 0.05% | 0.05% |
| Caffeine from Coffee | 0 | 0 | 0 |

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” or “the” may mean a singular object or element, or it may mean a plurality, or one or more of such objects or elements.

While particular embodiments of the invention and method steps of the invention have been described herein in terms of preferred embodiments, additional alternatives not specifically disclosed but known in the art are intended to fall within the scope of the disclosure. Thus, it will be apparent to those of skill in the art that variations may be applied to the devices and/or methods and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended claims.

1. A soluble coffee product comprising freeze dried roasted coffee, micro-milled roasted coffee and coffee oil.

2. The soluble coffee product of claim 1, further comprising spray dried coffee extract.

3. The soluble coffee product of claim 1, further comprising caffeine powder.

4. The soluble coffee product of claim 1, wherein the freeze dried coffee and the micro-milled coffee are made from Arabica coffee beans, Robusta coffee beans or a combination thereof.

5. A sealed container containing an amount of the coffee product of claim 1 to produce a single serving of coffee upon addition of the appropriate amount of hot water.

6. The sealed container of claim 5, wherein the amount is from 1.0 gram to 10.0 grams of soluble coffee product.

7. The sealed container of claim 5, further defined as a water, light, and air tight container with the headspace inside the package being flushed with either ambient air or nitrogen gas.

8. A stick pack which is a film, foil or film/foil-laminated stick pack containing enough soluble coffee product to make one serving.

9. A tub comprising a bottom surface with a substantially planar area, a top surface with a substantially planar area, and one or more side walls that connect the bottom surface to the top surface, and wherein the bottom surface, the top surface and the one or more side walls enclose the interior volume of the tub in an air and water tight seal, and further wherein the interior of the tub contains a single serving of a soluble coffee product comprising freeze dried roasted coffee, micro-milled roasted coffee and coffee oil.

10. The tub of claim 9, wherein the top surface and the bottom surface are circular in shape.

11. The tub of claim 10 in which the circumference of the top surface is larger that the circumference of the bottom surface.

12. The tub of claim 10 in which the top surface comprises foil or poly laminated foil.

13. The tub of claim 9, wherein the top and bottom surfaces each comprise a piercable portion.

14. A soluble coffee product comprising from about 50% to about 99% freeze dried coffee, from 0 to about 50% spray dried coffee, from 0 to about 25% micro-milled coffee, from 0 to about 5% coffee oil, from 0 to about 5% caffeine powder from coffee and from 0 to about 5% of other active natural occurring coffee components.

15. The coffee product of claim 14, further defined as comprising 91 to 92% medium roast freeze dried coffee, 2 to 8% spray dried espresso roast coffee, 5 to 6% micro-milled medium roast coffee, 0.01 to 0.5% coffee oil and 0 to 0.2% caffeine powder from coffee.

16. The coffee product of claim 14, further defined as comprising 91 to 92% freeze dried medium roast coffee, 4 to 5% spray dried medium roast coffee, 4 to 5% micro-milled medium roast coffee, 0.01 to 0.5% coffee oil and 0 to 0.2% caffeine powder from coffee.

17. The coffee product of claim 14, further defined as comprising 89 to 90% freeze dried medium roast coffee, 5 to 6% spray dried dark roast coffee, 5 to 6% micro-milled medium roast coffee, and 0.01 to 0.5% coffee oil.
